(19) United States
(12) Patent Application Publication
(10) Pub. No.: US 2018/0058406 A1
(43) Pub. Date: Mar. 1, 2018

(54) ENGINE STARTING SYSTEM

(71) Applicant: DENSO CORPORATION, Kariya-city (JP)

(72) Inventor: Tatsuya FUJITA, Kariya-city (JP)

(73) Assignee: DENSO CORPORATION, Kariya-city (JP)

(21) Appl. No.: 15/686,604

(22) Filed: Aug. 25, 2017

(30) Foreign Application Priority Data
Aug. 30, 2016 (JP) 2016-168544

(51) Int. Cl. F02N 11/08; F02N 11/00; F02N 11/04

(52) U.S. Cl. CPC F02N 11/087; F02N 11/006; F02N 2200/022; F02N 2200/061; F02N 2200/023; F02N 11/04

(57) ABSTRACT

An engine starting system is equipped with a starter and an alternator which work as engine starters to complete start-up of an engine mounted in a vehicle. The engine starting system obtains at least one of a first parameter correlating with an operating condition of the starter and a second parameter correlating with an operating condition of the alternator. The engine starting system controls an interval between a stop time of the starter and a start time of the alternator as a function of at least one of the first and second parameters, thereby ensuring the stability in completing the start-up of the engine.

### CROSS REFERENCE TO RELATED DOCUMENT

The present application claims the benefit of priority of Japanese Patent Application No. 2016-168544 filed on Aug. 30, 2016, the disclosure of which is incorporated herein by reference.

### BACKGROUND

### 1 Technical Field

The invention relates generally to an engine starting system.

### 2 Background Art

Engine starting system which are equipped with a combination of a gear drive type starter and a rotating electrical machine, such as an ISG (Integrated Starter Generator), have been proposed. This type of engine starting systems is designed to activate the starter at an initial stage when a large degree of torque is required to start the engine and then drive the ISG. This enables the ISG to be reduced in size or cost as compared with when the engine starting system is designed to use only the ISG to start the engine.

Japanese Patent No. 4421567 teaches an engine starting device using the above described starter and the ISG. The engine starting device is designed to use the starter (i.e., a starting motor) to crank the engine until the engine is fired for the first time and then use the ISG (i.e., an electrical motor) to crank the engine until the engine is stably fired up. The engine starting device has an overlap between on-durations of the starter and the ISG upon a transition in operation from the starter to the ISG.

When two starting devices: the starter and the ISG are used to complete the starting operation of the engine, conditions of the operation of the starting devices may be changed by various factors. This results in a variation in change in rotational speed of the engine in the on-durations of the starting devices, which adversely impinges on startability of the engine. For instance, when the speed of one of the starting devices drops, it deteriorates the startability of the engine.

### SUMMARY

It is therefore an object to provide an engine starting system which is capable of properly starting up an engine using a first starter and a second starter.

According to one aspect of the disclosure, there is provided an engine starting system which may be employed in vehicles such as automobiles. The engine starting system comprises: (a) a first starter; (b) a second starter; and (c) an engine start controller. The engine start controller is responsive to an engine start request to first actuate the first starter and then actuate the second starter for starting up an engine mounted in the vehicle. The engine start controller works to obtain at least one of a first parameter and a second parameter. The first parameter correlates with an operating condition of the first starter. The second parameter correlates with an operating condition of the second starter. The engine start controller controls an interval between a stop time at which the first starter is stopped and a start time at which the second starter is started as a function of the at least one of the first and second parameters.

When the first starter is first actuated, after which the second starter is actuated to complete start-up of the engine, it is preferable to optimize an on-duration in which each of the first and second starter is being driven. In terms of enhancement of startability of the engine, it is desirable to increase an overlap between the on-durations of the first and second starters. In terms of energy saving, it is desirable to decrease or eliminate the overlap between the on-durations of the first and second starters. The operating conditions of the first and second starters may be varied by various factors, which results in a variation in change in rotational speed of the engine cranked by the first starter and/or the second starter, thereby deteriorating the startability of the engine.

In view of the above fact, the engine starting system is designed to obtain at least one of the first parameter correlating with the operating condition of the first starter and the second parameter correlating with the operating condition of the second starter and control the interval between the stop time of the first starter and the start time of the second starter as a function of the at least one of the first and second parameters. The interval is a period of time for which the operations of the first and second starters overlap or do not overlap with each other. When the speed of the engine is expected to be insufficient while the first starter is operating, it is desirable to increase the degree to which the second starter assists in starting up the engine. Alternatively, when the second starter is expected to be insufficient in assisting the start-up of the engine, it is desirable to increase the degree to which the first starter works to start the engine at an early stage to start up the engine. In view of such facts, the engine starting system is capable of optimizing the actuation of the first and second starter to ensure the stability in completing the start-up of the engine.

In the second aspect of this disclosure, the engine start controller determines the start time of the second starter as a function of the first parameter to control the interval between the stop time of the first starter and the start time of the second starter.

The use of the first parameter correlating with the operating condition of the first starter enables the engine start controller to calculate the state of rotation of the engine for use in determining whether the first starter is in a condition capable of applying a desired degree of initial torque to the engine or not. The assistance of the second starter in starting up the engine is, therefore, optimized by determining the start time of the second starter using the first parameter.

In the third aspect of this disclosure, the engine start controller determines whether a speed of the engine cranked by the first starter is expected to fall in a low range smaller than a given threshold value or not using the first parameter. When it is determined that the speed of the engine is expected to fall in the low range, the engine start controller advances the start time of the second alternator.

When the speed of the engine driven by the first starter is expected to fall in the low range, it is desirable to increase the degree to which the second starter assist in starting up the engine. This is achieved, for example, by advancing the start time of the second starter to increase a period of time for which the actuation of the first starter overlaps with that of the second starter. This optimizes the assistance of the second starter in starting up the engine to improve the startability of the engine.

In the fourth aspect of this disclosure, the engine start controller obtains, as the first parameter, at least one of a peak value of a speed of the engine driven by the first starter, a rate of increase in speed of the engine driven by the first starter, a state of a power supply which works to delivers electric power to the first starter, and a cold condition of the engine.

The use of at least one of the peak value of the speed of the engine driven by the first starter, the rate of increase in speed of the engine driven by the first starter, the state of a power supply which works to delivers electric power to the first starter, and the cold temperature condition of the engine enables the engine start controller to calculate the state of rotation of the engine for use in determining whether the first starter is in a condition capable of applying a desired degree of initial torque to the engine or not. The engine start controller, thus, enables optimization of the actuation of the first and second starter.

In the fifth aspect of the disclosure, the engine start controller determines the stop time of the first starter as a function of the second parameter to control the interval between the stop time of the first starter and the start time of the second starter.

The use of the second parameter correlating with the operating condition of the second starter enables the engine start controller to calculate the degree to which the second starter is capable of assisting start-up of the engine for use in determining whether the second starter is expected to desirably assist in starting up the engine or not. The engine start controller is, therefore, capable of determining the stop time of the first starter as a function of the second parameter to optimize the actuation of the first starter in view of the ability of the second starter to complete the start-up of the engine.

In the sixth aspect of this disclosure, the engine start controller determines whether the second starter is in an insufficient-assist condition where the second starter is expected to be insufficient in assisting starting up the engine or not. When the second starter is determined to be in the insufficient-assist condition, the engine start controller delays the stop time of the first starter.

When the second starter is expected to insufficiently assist in starting up the engine, it is desirable to increase a load on the first starter to start the engine as compared with that on the second starter. This is achieved by delaying the stop time of the first starter to increase an overlap between the on-durations of the first and second starters, thereby increasing the load on the first starter to crank the engine to improve the startability of the engine.

In the seventh aspect of this disclosure, the engine start controller obtains, as the second parameter, at least one of information about a starting condition of the second starter, a state of a power supply delivering electric power to the second starter, and a cold condition of the engine.

The use of at least one of the information about the starting condition of the second starter, the state of the power supply delivering electric power to the second starter, and the cold condition of the engine enables the engine start controller to determine whether the second starter is capable of desirably starting up the engine or not. The engine start controller is, thus, enabled to optimize the actuation of the first and second starters.

In the eighth aspect of this disclosure, the engine start controller is designed to operate in a control mode to control an operation of each of the first starter and the second starter based on at least one of the first and second parameters. The control mode includes a mode in which the second starter is inhibited from operating.

For instance, when the first starter is in a condition capable of desirably starting the engine, while the second starter is in a condition not capable of desirably completing the start-up of the engine, it is preferable to only use the first starter to complete the start-up of the engine. In view of this situation, the engine start controller is designed to operate in the above control mode to ensure the stability in starting up the engine.

In the ninth aspect of this disclosure, the engine starting system is designed to have a first power supply for the first starter and a second power supply for the second starter. The engine start controller obtains the first parameter when it is required to actuate the first starter using electric power delivered from the first power supply and also obtains the second parameter when it is required to actuate the second starter using electric power delivered from the second power supply.

When one of the first and second power supplies is in an undesirable state, while the other of the first and second power supplies is in a required state, the engine start controller may control the actuation of the first and second starters using at least one of the first parameter and the second parameter, thereby optimizing the start-up of the engine.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which illustrates a structure of an engine starting system according to the first embodiment;

FIG. 2(a) is a time chart which demonstrates a change in speed of an engine when starters are capable of desirably operating;

FIG. 2(b) is a time chart which demonstrates a change in speed of an engine when starters are not capable of desirably operating;

FIG. 3 is a flowchart of a sequence of logical steps performed by an ECU installed in the engine starting system of FIG. 1;

FIG. 4 is a view which represent a relation between an advanced start time of an alternator and an estimated engine speed;

FIG. 5 is a view which represents a relation between an advanced start time of an alternator and an internal resistance of a battery;

FIG. 6 is a flowchart of a starting program executed by a controller installed in the engine starting system of FIG. 1;

FIG. 7 is a time chart which represents operations of the engine starting system of FIG. 1;

FIG. 8 is a flowchart of a sequence of logical steps performed by an ECU in a modification of the engine starting system of FIG. 1;

FIG. 9 is a flowchart of a sequence of logical steps performed by an ECU in another modification of the engine starting system of FIG. 1;

FIG. 10 is a flowchart of a sequence of logical steps performed by an ECU installed in an engine starting system according to the second embodiment;

FIG. 11 is a flowchart of a starting program executed by a controller installed in an engine starting system of the second embodiment;

FIG. 12 is a time chart which demonstrates operations of the engine starting system of the second embodiment;

FIG. 13 is a block diagram which illustrates a structure of an engine starting system according to the third embodiment;

FIG. 14 is a flowchart of a sequence of logical steps performed by an ECU installed in the engine starting system of FIG. 13;

FIG. 15 is a view which represents a relation between an internal resistance of a battery and a stop time of a starter; and

FIG. 16 is a flowchart of a sequence of logical steps performed to start an engine in a modified form of an engine starting system.

### DESCRIPTION OF THE PREFERRED EMBODIMENT

An engine starting system according to an embodiment will be described below with reference to the drawings. Throughout the drawings, the same reference numbers refer to the same parts, and duplicated explanation thereof will be omitted here.

### First Embodiment

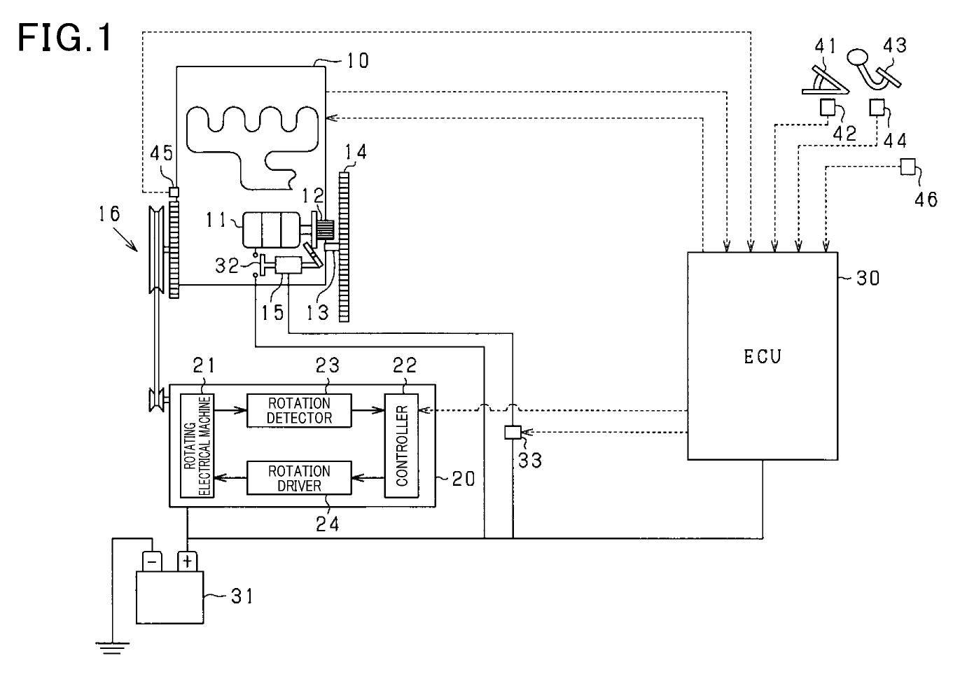

The engine starting system is installed in a vehicle, such as an automobile, in which an engine 10 is mounted as a drive source. The engine 10 is, as illustrated in FIG. 1, a multi-cylinder internal combustion engine driven by combustion of fuel such as gasoline or light oil and equipped with known ignition devices.

The engine 10 is equipped with the starter 11 working as a gear-driven first starter. The pinion 12 is mounted on a rotating shaft of the starter 11. The pinion 12 is engageable with the ring gear 14 mounted on the engine rotating shaft 13. The starter 11 has installed therein the solenoid 15 which works to push or shift the pinion 12 into engagement with the ring gear 14. The solenoid 15, therefore, works as an actuator for the pinion 12. When it is required to start the engine 10, the solenoid 15 is energized to move the pinion 12 in an axial direction of the starter 11 into engagement with the ring gear 14 to provide torque, as produced by the starter 11, to the engine rotating shaft 13.

The starter 11 is electrically connected to the battery 31 working as a power supply. Specifically, the solenoid 15 and the battery 31 are joined together through the relay 33. When the relay 33 is closed so that it is connected, electric power is delivered from the battery 31 to the solenoid 15. The solenoid 15 then shifts the pinion 12 to an engageable location where the pinion 12 is permitted to mesh with the ring gear 14. When the pinion 12 is shifted, the switch 32 is turned on so that it is closed, thereby actuating the starter 11. When the relay 33 is opened, the supply of electric power from the battery 31 to the solenoid 15 is cut, thereby causing the pinion 12 to be returned by, for example, a spring (not shown) back to an initial position thereof to disengage the pinion 12 from the ring gear 14. This also causes the switch 32 to be turned off or opened, so that the starter 11 is stopped from rotating. The relay 33 is, as described later in detail, opened or closed in response to a drive signal outputted form the ECU 30.

The alternator 20 is connected to the engine rotating shaft 13 through the power transmission mechanism 16 which includes pulleys and a belt. The alternator 20 works as a belt-driven second starter to selectively transmit torque to the engine rotating shaft 13. The alternator 20 is joined to the engine rotating shaft 13 through the power transmission mechanism 16 at all times. The alternator 20 selectively operates in one of a motor mode and a generator mode (also called a regenerative mode). When it is required to supply the power to the engine rotating shaft 13, the alternator 20 enters the motor mode. Alternatively, when it is required to convert the output of the engine 10 into electrical power, the alternator 20 enters the generator mode.

The starter 11 is engineered as an engine starter which is electrically turned on or off in response to the drive command, while the alternator 20 is engineered as an engine starter whose rotational speed is controlled in the motor mode. The starter 11 is of a low-speed type to produce a relatively great degree of torque, while the alternator 20 is of a high-speed type.

The alternator 20 is equipped with the rotating electrical machine 21, the controller 22, the rotation detector 23 working to measure a flow of electrical current through the rotating electrical machine 21, and the rotation driver 24 working to deliver electrical power to the rotating electrical machine 21. The rotating electrical machine 21 is designed as a three-phase AC electrical rotating machine to have a known structure equipped with a rotor coil wound around a rotor and a stator coil wound around a stator. The rotation driver 24 is implemented by a known inverter circuit equipped with a plurality of switching devices, i.e., MOSFETs and works to convert dc power, as delivered from the battery 31, into ac power and supply it to the rotating electrical machine 21. The rotation driver 24 also works to convert ac power, as delivered from the rotating electrical machine 21, into dc power and supply it to the battery 31. The battery 31 works as an electrical power supply to deliver the electrical power to the starter 50 and the alternator 20.

The controller 22 works to control the speed of rotation of the alternator 20. When it is required to operate the alternator 20 in the motor mode, the controller 22 actuates the rotation driver 24 to convert dc power from the battery 31 into three-phase electric power and delivers it to the stator coil. The controller 22 also analyzes a value of electric current, as measured by the rotation detector 23, to control the operation of the rotation driver 24 for bringing the speed of the rotating electrical machine 21 into agreement with a target value.

When the alternator 20 is placed in the generator mode, the stator coil generates ac induced electromotive force whose frequency depends upon the speed of the rotating electrical machine 21. The rotation detector 23, therefore, measures such induced electromotive force to determine the speed of the rotating electrical machine 21.

The alternator 20 of this embodiment is engineered to have a sensor-less structure which is not equipped with a rotation sensor. The rotation detector 23 works to measure induced voltage or induced current, as generated in the rotor coil or the stator coil by rotation of the rotor of the rotating electrical machine 21. The controller 22 analyzes the induced voltage or current, as measured by the rotation detector 23, to determine that the rotating electrical machine 21 is rotating or determine a target one of phase windings of the rotating electrical machine 21 which should be excited. The controller 22 then excites the target phase winding to drive the rotating electrical machine 21 in the motor mode.

The speed of rotation of the rotating electrical machine 21 and a speed reduction ratio of the power transmission mechanism 16 may be used to calculate the engine speed NE that is the speed of rotation of the engine rotating shaft 16. The engine rotating shaft 13 is connected to wheels of the vehicle through a clutch and a transmission (not shown). Such arrangements are known, and explanation thereof in detail will be omitted here.

The engine starting system is also equipped with the ECU (Electronic Control Unit) 30 working to execute engine control. The EUC 30 is made of a known electronic control unit equipped with a microcomputer and works to analyze outputs from various sensors installed therein to execute control tasks for the engine 10. The ECU 30 is connected to the controller 22 to establish intercommunication therebetween. The ECU 30 is electrically connected to the battery 31 and operated by electric power delivered from the battery 31. The ECU 30, as will be described later in detail, serves as an engine start controller alone or together with the controller 22.

The above sensors include the accelerator position sensor 42, the brake sensor 44, the speed sensor 45, the vehicle speed sensor 46, and the air flow meter 14. The accelerator position sensor 42 works to measure the position of the accelerator pedal 41, i.e., a driver's effort on the accelerator pedal 41 which serves as an acceleration operating member. The brake sensor 44 works to measure the position of the brake pedal 43. The speed sensor 45 works to measure the angular position of the engine rotating shaft 16 at a given angular interval thereof for determining the speed of the engine rotating shaft 16. The vehicle speed sensor 46 works to measure the speed of the vehicle. These sensors provide outputs to the ECU 30. The engine starting system is also equipped with other sensors (not shown).

The ECU 30 uses outputs of the above sensors to control the quantity of fuel to be sprayed from fuel injectors into the engine 10 and the ignition of fuel using ignition devices in the engine 10. The ECU 30 also works to control an on-off operation of the starter 11. The ECU 30 also controls a known idle stop mode of the engine 10. Specifically, in the idle stop mode, the ECU 30 automatically stops the engine 10 when given automatic engine stop conditions are encountered and then automatically restarts the engine 10 when given engine restart conditions are met. The automatic engine stop and restart conditions include the speed of the vehicle, the accelerating operation, and the braking operation.

When the starter 11 and the alternator 20 are selectively used to start the engine 10, the starter 11 is actuated at an early stage where a large degree of torque is required to rotate the engine 10, and then the alternator 20 is actuated to complete the starting operation of the engine 10. The condition of the operation of the starter 11, however, may be changed by various factors. This results in a variation in change in rotational speed NE of the engine 10 in the on-duration of the starter 11, which adversely impinges on startability of the engine 10.

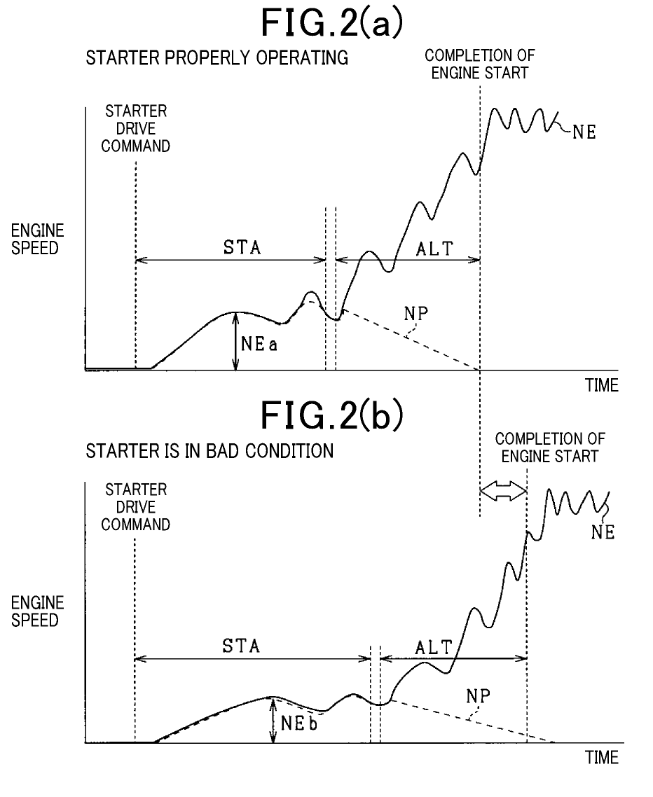

A basic engine starting operation of the engine starting system using the starter 11 and the alternator 20 will be described below with reference to FIGS. 2(a) and 2(b). FIG. 2(a) demonstrates an engine starting operation when the starter 11 is properly operating. FIG. 2(b) demonstrates an engine starting operation when the starter 11 is not desirably operating. FIG. 2(a) illustrates an example where the on-durations (which will also be referred to below as drive durations) of the starter 11 and the alternator 20 do not overlap each other.

When the ECU 30 outputs a starter drive signal, the starter 11 is then actuated. The speed NP of the starter 11 arises, so that the engine speed NE increases. When a given crank angle position is reached, the ECU 30 turns off the starter 11 and then outputs an alternator drive signal to actuate the alternator 20. Specifically, after the starter 11 is turned off, only the alternator 20 is driven to complete the starting operation of the engine 10.

The engine speed NE when the starter 11 is properly operating is higher than when the starter 11 is not properly operating. In other words, peak values ENa and ENb of the engine speed NE appearing for the first time (i.e., a cranking speed) meets a relation of NEa>NEb. The time when a given crank angle (i.e., an angular positon of the crankshaft of the engine 10) at which the starter 11 should be stopped is reached in the example of FIG. 2(a) is earlier than that in the example of FIG. 2(b). This enables the time of switching from actuation of the starter 11 to that of the alternator 20 to be advanced to complete the starting operation of the engine 10 in the example of FIG. 2(a). In the example of FIG. 2(b), it takes a longer time to reach the given crank angle, thereby resulting in a delay of switching from the actuation of the starter 11 to that of the alternator 20. It, therefore, takes an increased time to complete the starting operation of the engine 10, which deteriorates the startability of the engine 10.

In view of the above fact, the engine starting system of this embodiment is designed to obtain a first parameter correlating with an operating condition of the starter 11, calculate a start time that is a target time at which the alternator 20 should be started, i.e., turned on using the first parameter, and control a time interval between the time (i.e., a stop time) when the starter 11 should be turned off and the start time when the alternator 20 should be turned on. In other words, the engine starting system determines the start time when the alternator 20 should be started as a function of the first parameter to optimize assistance for starting the engine 10 by the alternator 20. For example, the first parameter is a parameter correlating with a change in speed of the engine 10 when the starter 11 is being driven.

In this embodiment, the first parameter includes at least one of a peak value of the speed (i.e., the cranking speed) of the engine 10 when the starter 11 is being driven, a rate of change in increasing speed of the engine 10, a state (e.g., a terminal voltage or a degree of aging) of the battery 31 which supplies electrical power to the starter 11, and a cold condition of the engine 10 (e.g., an ambient temperature or temperature of engine coolant).

The start time when the alternator 20 should be started to be actuated will be described below in detail. The engine starting system sets a reference start time in advance as the start time of the alternator 20 so as not to have an overlap between actuation of the starter 11 and that of the alternator 20 when the speed of the engine 10 driven or cranked by the starter 11 is expected to lie in a good or desired range. In other words, the engine starting system starts actuating the alternator 20 after the starter 11 is completely stopped from operating.

Alternatively, when the speed of the engine 10 cranked by the starter 11 is expected to fall in a low-speed range smaller than a given value, the engine starting system advances the start time of the alternator 20 to be earlier than the given reference start time in order to increase the degree to which the alternator 20 assists in cranking the engine 10 for enhancing the startability of the engine 10.

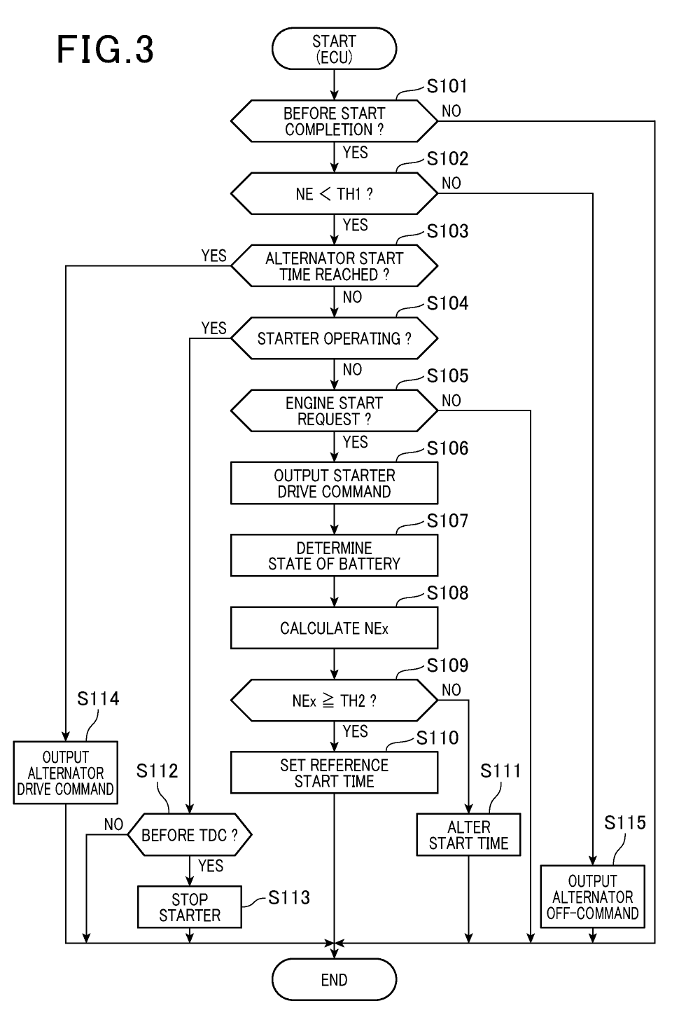

FIG. 3 is a flowchart of a sequence of logical steps or program executed by the ECU 30 in a selected control cycle.

After entering the program, the routine proceeds to step S101 wherein it is determined whether a starting operation to start the engine 10 is not yet completed or not. For instance, when the engine 10 has been automatically stopped in the idle stop mode, but before having been completely restarted, a YES answer is obtained in step S101. When the engine 10 has been restarted, the routine then terminates. If a YES answer is obtained in step S101 meaning that the starting operation is not yet finished, then the routine proceeds to step S102 wherein it is determined whether the engine speed NE is lower than a given threshold value TH1 or not. The threshold value TH1 is used as a reference value in determining whether the motor mode of the alternator 20 should be stopped or not. The threshold value TH1 is set to, for example, 500 rpm. If a YES answer is obtained in step S102, then the routine proceeds to step S103. Alternatively, if a NO answer is obtained, then the routine proceeds to step S114.

In step S103, it is determined whether the start time, as determined by the ECU 30, has been reached or not. If a YES answer is obtained, i.e., the start time has been reached, then the routine proceeds to step S114. Alternatively, if a NO answer is obtained, then the routine proceeds to step S104.

In step S104, it is determined whether the starter 11 is being driven or not. Specifically, it is determined the drive command to actuate the starter 11 has already been outputted or not. If a NO answer is obtained meaning that the starter 11 is still not operating, then the routine proceeds to step S105 wherein it is determined whether an engine start request to start the engine 10 has been made or not. When an engine restart request is made after the engine 10 is automatically stopped, a YES answer is obtained in step S105. The routine then proceeds to step S106. A NO answer is obtained in step S105 until the engine restart request is made after the engine 10 is automatically stopped. The routine then terminates.

In step S106, the starter drive command is outputted to the relay 33 to actuate the starter 11. The routine then proceeds to step S107 wherein the first parameter which represents the state of the battery 31 is derived. Specifically, the ECU 30 obtains an internal resistance of the battery 31 which usually changes as a function of the degree of aging of the battery 31. The greater the internal resistance, the greater the degree of aging of the battery 31. When the internal resistance of the battery 31 is increased, it will cause the amount of electrical power delivered to the starter 11 to be decreased, which results in a decrease in rate of rise in the engine speed NE during cranking of the engine 10, that is, the starter 11 is being operating. The internal resistance of the battery 31 may be determined in a known way. For instance, the internal resistance of the battery 31 may be derived as a function of the voltage at the battery 31 or electrical current flowing from the battery 31. Alternatively, the internal resistance of the battery 31 which was measured when the engine 10 was operated previously may be used in step S107. Subsequently, the routine proceeds to step S108 wherein an estimated engine speed NEx is calculated as a function of the internal resistance of the battery 108, as derived in step S107. The estimated engine speed NEx is the speed of the engine 10 (i.e. the cranking speed of the engine 10) expected in this engine cranking cycle.

The ECU 30 may monitor the terminal voltage at the battery 31 as indicating the state of the battery 31 before the electrical power starts to be delivered to the starter 11 and determine the estimated engine speed NEx in view of the fact that the lower the terminal voltage at the battery 31, the smaller the electrical current supplied to the starter 11.

Subsequently, the routine proceeds to step S109 wherein it is determined whether the estimated engine speed NEx, as calculated in step S108, is greater than or equal to a given threshold value TH2 or not. The threshold value TH2 is a reference value for use in determining whether the engine speed NE (i.e., the cranking speed) driven by the starter 11 will become low or not. The threshold value TH2 is set to, for example, 150 rpm which is lower than 200 rpm that is the cranking speed of the engine 10 when the starter 11 is capable of properly operating. If a YES answer is obtained in step S109 meaning that the speed of the engine 10 will not be undesirably low, then the routine proceeds to step S110 wherein the start time at which the alternator 20 should be started is set to the reference start time without being changed.

If a NO answer is obtained in step S109 meaning that the speed of the engine 10 will become undesirably low, then the routine proceeds to step S111 wherein the start time of the alternator 20 is advanced. In other words a target time when the alternator 20 should be started is advanced based on the reference start time.

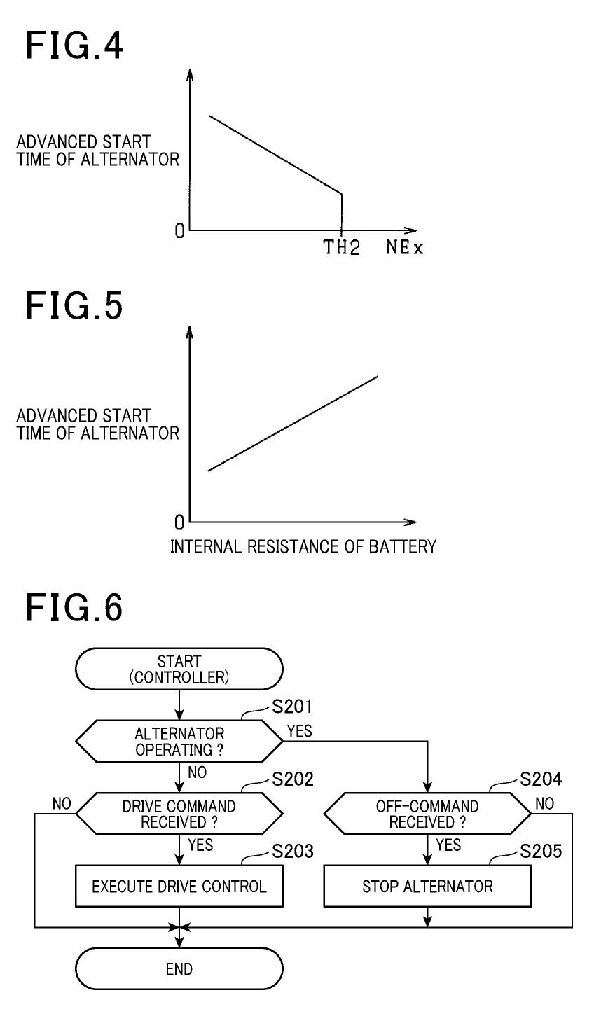

In step S111, the start time of the alternator 20 may be set a preselected early time using a map in FIG. 4. The map represents a relation between the estimated engine speed NEx and a target time to which the start time should be advanced. In the example of FIG. 4, when the estimated engine speed NEx is higher than or equal to the threshold value TH2, the target time to which the start time should be advanced is determined to be zero. This means that the start time is not changed. The start time of the alternator 20 is advanced as the estimated engine speed NEx becomes smaller than the threshold value TH2. In other words, as the engine speed NE is expected to undesirably become decreased when the starter 11 is driven, the ECU 30 early starts actuating the alternator 20 to increase the degree to which the engine starting system assists in starting the engine 10.

The internal resistance of the battery 31 has a correlation with the speed of the engine 10 when the starter 11 is actuated to crank the engine 10. The ECU 30 may determine or change the start time of the alternator 20 as a function of the internal resistance of the battery 31. For example, the ECU 30 determines the start time of the alternator 20 by look-up using a map of FIG. 5. The map represents a relation between the internal resistance of the battery 31 and a target time to which the start time should be advanced. In the example of FIG. 5, the higher the internal resistance of the battery 31, the more the start time is advanced.

After the starter 11 is actuated, that is, if a YES answer is obtained in step S104, then the routine proceeds to step S112 wherein it is determined whether an angular position of the engine 10 (i.e., an angular positon of the crankshaft of the engine 10) is just before the top dead center (TDC) of the piston in the compression stroke nor not. For instance, it is determined whether the angular position of the engine 10 is in a range of BTDC 45° to 5° CA or not. An angular position of the engine 10 just before the top dead center represents a point just before the pressure of compressed air in the cylinder of the engine 10 is maximized. If a YES answer is obtained in step S112 meaning that a current position of the engine 10 is just prior to TDC, then the routine proceeds to step S113. Alternatively, if a NO answer is obtained in step S112, then the routine terminates, so that the ECU 30 continues to drive the starter 11. In step S113, the relay 33 is opened to stop actuating the starter 11.

If a YES answer is obtained in step S103 meaning that the start time of the alternator 20 which has already been set is reached, then the routine proceeds to step S114 wherein the ECU 30 outputs the alternator drive command (i.e., an alternator on-signal) to the controller 22.

If a NO answer is obtained in step S102 after the alternator 20 is actuated, so that the engine speed NE rises and exceeds the threshold value TH1, then the routine proceeds to step S115 wherein the ECU 30 outputs an off-signal to terminate the motor mode of the alternator 20. The routine then terminates.

FIG. 6 represents drive control for the alternator 20 which is executed by the controller 22 in a given control cycle which may be identical with or different from that in the ECU 30.

After entering the program, the routine proceeds to step S201 wherein it is determined whether the alternator 20 is now operating or not. If a YES answer is obtained meaning that the alternator 20 is being driven, then the routine proceeds to step S204. Alternatively, if a NO answer is obtained, then the routine proceeds to step S202.

In step S202, it is determined whether the controller 22 has received the alternator drive command from the ECU 30 or not, that is, whether the alternator 20 is permitted to operate in the motor mode or not. If a NO answer is obtained in step S202 meaning that the alternator 20 is inhibited from operating in the motor mode, the routine then terminates without placing the alternator 20 in the motor mode. Alternatively, if a YES answer is obtained in step S202 meaning that the alternator 20 is permitted to be driven in the motor mode, then the routine proceeds to step S203 wherein the drive control is executed to drive the alternator 20.

When the alternator 20 starts to be driven, a YES answer is obtained in step S201. The routine then proceeds to step S204 wherein it is determined whether the controller 22 has received the alternator-off signal from the ECU 30 or not. If a NO answer is obtained, then the routine terminates, so that the controller 22 continues to drive the alternator 20.

Alternatively, if a YES answer is obtained in step S204, then the routine proceeds to step S205 wherein the controller 22 stops operating the alternator 20 to complete the starting operation for the engine 10.

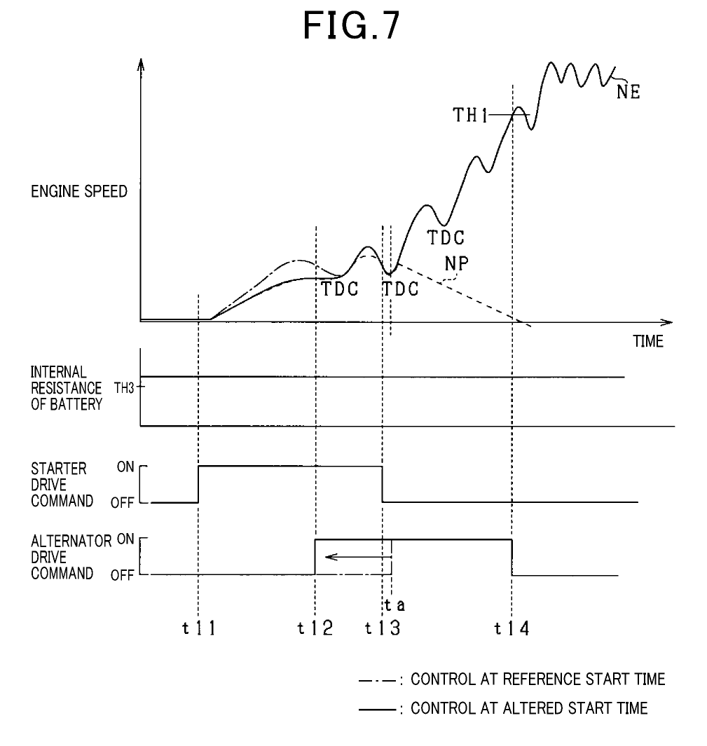

FIG. 7 is a time chart which represents operations of the engine starting system to start the engine 10. FIG. 7 demonstrates an example where the engine 10 is automatically stopped and then restarted.

Before time t11, the engine 10 is at rest. At time t11, the driver of the vehicle makes an engine start request for the engine 10. Specifically, when the driver depresses the accelerator pedal or releases the brake pedal, the engine start request is made. For instance, in a case where it is required to start the engine 10 for the first time, the engine start request is produced upon turning on an ignition key of the vehicle by the driver.

When the engine start request is made, the ECU 30 starts energizing the starter 11 to crank the engine 10. The ECU 30 also calculates the estimated engine speed NEx when the starter 11 is driven and determines the start time of the alternator 20. Specifically, the ECU 30 obtains the internal resistance of the battery 31 and calculates the estimated engine speed NEx as a function of the internal resistance. In the example of FIG. 7, the internal resistance of the battery 31 is higher than or equal to the threshold value TH3 meaning that the battery 31 is not capable of delivering a required amount of electric power to the starter 11. The ECU 30, therefore, concludes that the engine speed NE is not expected to increase up to a desired value and then changes the reference start time for starting the alternator 20 from time to to time t12.

At time t12, the ECU 30 outputs the alternator drive signal to start actuating the alternator 20. Subsequently, when time t13 just before a given TDC of the piston of the engine 10 is reached, the ECU 30 outputs the off-signal to turn off the starter 11.

Afterwards, the engine speed NE is increased by the cranking operation of the alternator 20 and self-rotation of the engine 10 achieved by combustion of fuel in the engine 10. When the engine speed NE reaches the threshold value TH1 at time t14, the ECU 30 outputs the off-signal to the controller 22 for turning off the alternator 20. The controller 22 stops actuating the alternator 20 to terminate the cranking of the engine 10.

In the above way, the ECU 30 advances the start time of the alternator 20 to achieve a desired rise in the engine speed NE during cranking of the engine 10. In the example of FIG. 7, an overlap between the on-durations of the starter 11 and the alternator 20 lies between time t12 and time t13.

The engine starting system of this embodiment offers the following beneficial advantages.

In a case where two starting devices: the starter 11 and the alternator 20 are used to complete the starting of the engine 10, and the starter 11 is first actuated, after which the alternator 20 is actuated, it is preferable to optimize the on-durations for which the starter 11 and the alternator 20 are actuated. The condition of the operation of the starter 11 may be changed by various factors. This may result in a variation in change in rotational speed of the engine 10 when being cranked by the starter 11, which adversely impinges on the startability of the engine 10. In order to alleviate such a drawback, the engine starting system of this embodiment is engineered to derive the first parameter correlating with the operational condition of the starter 11 and determine or control an interval between the time when the starter 11 should be turned off and the start time when the alternator 20. For instance, when it is impossible for the starter 11 to produce a degree of torque which is great enough to apply desired initial torque to the engine 10, it is required to increase the degree to which the alternator 20 assists in cranking the engine 20. To this end, the engine starting system of this embodiment execute the above described start control tasks to ensure the stability in starting the engine 10 using the starter 11 and the alternator 20.

Specifically, the engine starting system determines the start time of the alternator 20 based on the first parameter. The first parameter, as described above, correlates with the operational state of the starter 11. This enables the ECU 30 to obtain the state of rotation of the engine 10 using the first parameter when the engine 10 is being driven by the starter 11. The ECU 30, thus, determines whether the starter 11 is capable of applying a required degree of torque to initially crank the engine 10 or not and calculate the start time of the alternator 20 as a function of the first parameter in order to ensure a desired degree of assistance in completing the starting of the engine 10 using the alternator 20.

When the engine speed NE, as derived by the cranking operation of the starter 11, is expected to become lower than the given value, it is necessary to increase the degree to which the alternator 20 assists in cranking the engine 10. To this end, the engine starting system works to advance the start time of the alternator 20 to increase the length of time the on-duration of the starter 11 overlaps that of the alternator 20, in other words, control an interval between the stop time of the starter 11 and the star time of the alternator 20, thereby optimize the assistance of the alternator 20 in cranking the engine 10 to ensure the startability of the engine 10.

The engine starting system obtains, as the first parameter, the state (e.g., the terminal voltage or degree of aging) of the battery 31 which supplies electrical power to the starter 11, thereby facilitating the ease with which it is determined whether the starter 11 is now capable of applying a required degree of initial torque to the rotating shaft of the engine 10 when being required to be started. This achieves a good balance between actuation of the starter 11 and the alternator 20 for stating up the engine 10.

When the starter 11 is expected to properly operate, it is not necessarily required to start actuating the alternator 20 before the starter 11 is completely turned off. The engine starting system is, therefore, designed not to have an overlap between actuation of the starter 11 and the alternator 20 when the starter 11 is determined as being capable of properly cranking the engine 10 without the assistance of the alternator 20. This minimizes energy consumed in starting up the engine 10.

### Modification of First Embodiment

The engine starting system of the first embodiment is designed to output the drive command to the starter 11 when it is required to start the engine 10, monitor the state parameter of the battery 31 to calculate the engine speed NEx that is the speed of the engine 10 expected in this engine cranking cycle, and determine the start time of the alternator 20 as a function of the engine speed NEx (see steps S107 to S111 in FIG. 3), but however, may alternatively be engineered to determine a peak value of the speed of the engine 10 (i.e., the cranking speed) when the starter 11 is operating and calculate the start time of the alternator 20 as a function of the peak value.

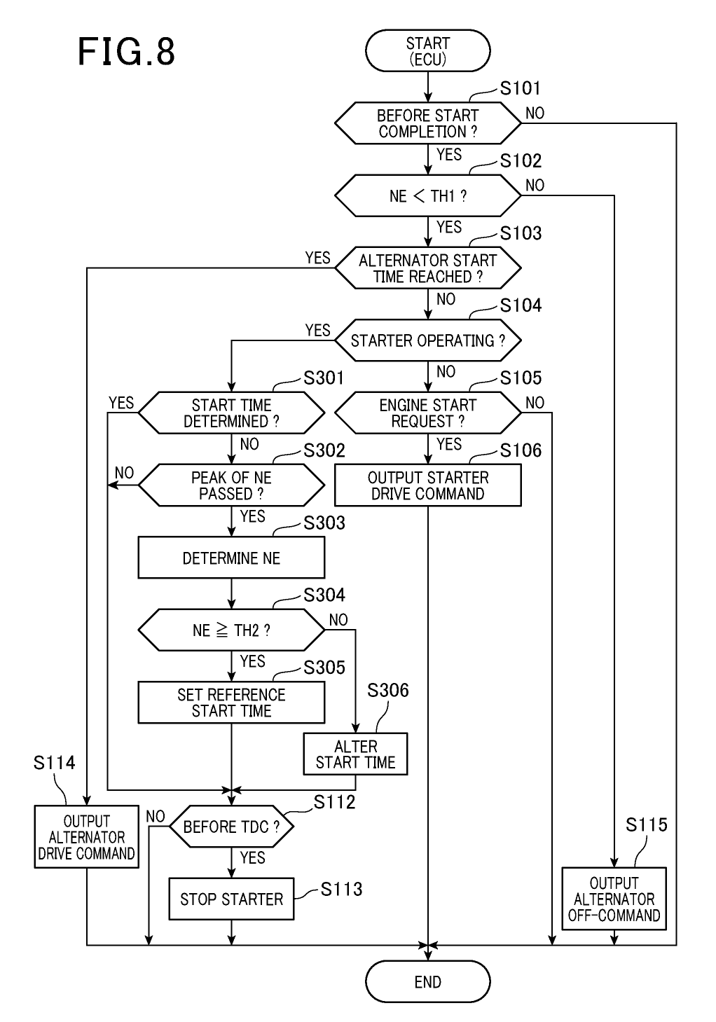

The above structure will be described in detail with reference to a flowchart of FIG. 8. The flowchart of FIG. 8 is a sequence of logical steps executed by the ECU 30 in a cycle instead of that in FIG. 3. The same step numbers as employed in FIG. 3 refer to the same operations, and explanation thereof in detail will be omitted here. The flowchart of FIG. 8 omits steps S107 to S111 from that of FIG. 3 and additionally has steps S301 to 306.

In FIG. 8, when the start of the engine 10 has not yet been completed, and the engine speed NE is lower than the threshold value TH1, that is, YES answers are obtained in steps S101 and S102, the routine proceeds to step S103 wherein it is determined whether the start time of the alternator 20 has been reached. If a NO answer is obtained, then the routine proceeds to step S104 wherein it is determined whether the starter 11 is being driven in response to the engine start request or not. If a YES answer is obtained, then the routine proceeds to step S301 wherein it is determined whether the start time of the alternator 20 has been determined or not. If a NO answer is obtained, then the routine proceeds to step S302 wherein it is determined whether the speed of the engine 10 has passed the peak value thereof or not. If a YES answer is obtained meaning that the peak value of the speed of the engine 10 has been passed, then the routine proceeds to step S303 wherein the peak value, i.e., the cranking speed is derived.

Subsequently, the routine proceeds to step S304 wherein it is determined whether the engine speed NE is higher than or equal to the threshold value TH2 or not. If a YES answer is obtained, then the routine proceeds to step S305 wherein the start time of the alternator 20 is set to the reference start time. Alternatively, if a NO answer is obtained in step S304, then the routine proceeds to step S306 wherein the start time of the alternator 20 is advanced in the same way as described in the first embodiment. The following steps are identical with those in FIG. 3. The start time of the alternator 20 is advanced with a decrease in peak value of the engine speed NE.

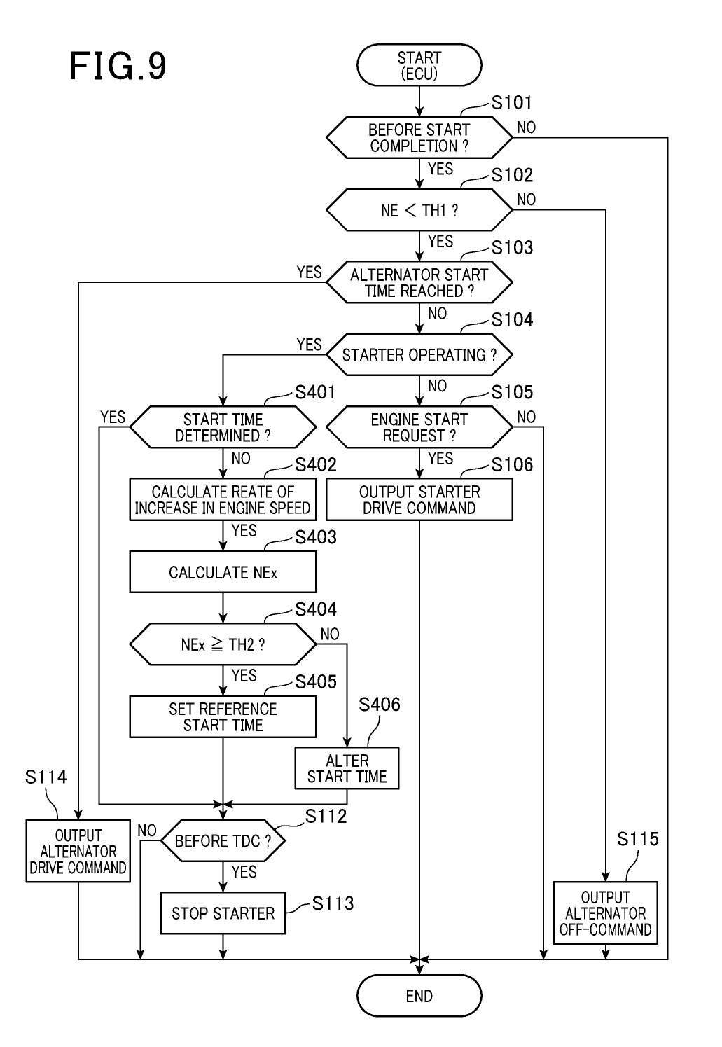

The engine starting system may alternatively be engineered to determine the start time of the alternator 20 as a function of a rate of increase in speed of the engine 10 immediately after the starter 11 is actuated. This structure will be described below in detail with reference to a flowchart of FIG. 9.

The flowchart of FIG. 9 is a sequence of logical steps executed by the ECU 30 in a cycle instead of that in FIG. 3. The same step numbers as employed in FIG. 3 refer to the same operations, and explanation thereof in detail will be omitted here. The flowchart of FIG. 9 omits steps S107 to S111 from that of FIG. 3 and additionally has steps S401 to 406.

In FIG. 9, when the start of the engine 10 has not yet been completed, and the engine speed NE is lower than the threshold value TH1, that is, YES answers are obtained in steps S101 and S102, the routine proceeds to step S103 wherein it is determined whether the start time of the alternator 20 has been reached or not. If a NO answer is obtained, then the routine proceeds to step S104 wherein it is determined whether the starter 11 is being driven in response to the engine start request or not. If a YES answer is obtained, then the routine proceeds to step S401 wherein it is determined whether the start time of the alternator 20 has been determined or not. If a NO answer is obtained, then the routine proceeds to step S402 wherein a rate of increase in the engine speed NE is calculated as a function of a change in the engine speed NE. The change in the engine speed NE is derived at a given angular interval of the engine 10 (i.e., the crankshaft of the engine 10) by the ECU 30 after the starter 11 is turned on. The routine then proceeds to step S403 wherein the engine speed NEx that is the speed of the engine 10 expected to be derived as the cranking speed in this cranking cycle is estimated or calculated as a function of the rate of increase in the engine speed NE.

Subsequently, the routine proceeds to step S404 wherein it is determined whether the estimated engine speed NEx is higher than or equal to the threshold value TH2 or not. If a YES answer is obtained, then the routine proceeds to step S405 wherein the start time of the alternator 20 is set to the reference start time. Alternatively, if a NO answer is obtained in step S404, then the routine proceeds to step S406 wherein the start time of the alternator 20 is advanced in the same way as described in the first embodiment. The following steps are identical with those in FIG. 3.

The engine starting system may alternatively be engineered to determine the start time of the alternator 20 using a plurality of parameters as the first parameter. For instance, the first parameter may include a parameter indicating the state of the battery 31 and a parameter indicating the speed of the engine 10 (i.e., the cranking speed) when the starter 11 is driven. The engine starting system uses such parameters to calculate a plurality of start times of the alternator 20 as functions of the above respective parameters. The engine starting system selects the earlier of the start times as the start time at which the alternator 20 should be turned on and starts actuating the alternator 20 when the selected start time is reached. The determination of the start time in this way may be made using another additional parameter. The use of a plurality of different parameters as the first parameter further optimizes the determination of the start time of the alternator 20. The selection of the earlier of a plurality of start times of the alternator 20 determined using a plurality of parameters as the first parameter compensates for insufficient assistance in starting up the engine 10, that is, enhances the startability of the engine 10.

The engine starting system may alternatively be designed to select the later or middle of a plurality of start times calculated using a plurality of different parameters in the same way as described above as the start time when the alternator 20 should be started.

The engine starting system is, as described above, designed to advance the start time of the alternator 20 to overlap the on-duration of the starter 11 with that of the alternator 20 and also increase the duration of the overlap depending upon the performance of the starter 11, but may alternatively engineered to advance the start time of the alternator 20 within a range where the on-duration of the starter 11 does not overlap that of the alternator 20. This also enhances the assistance of the alternator 20 in starting up of the engine 10 and keeps the quantity of electric power consumed to crank the engine 10 low.

### Second Embodiment

The engine starting system of the second embodiment will be described below. The engine starting system of the first embodiment determines the start time of the alternator 20 using a parameter correlating with the operational condition of the starter 11, while the engine starting system of the second embodiment works to determine a stop time that is a target time at which the starter 11 should be stopped, i.e., turned off using a parameter correlating with the operational condition of the alternator 20.

At the starting stage of the engine 10 using the starter 11 and the alternator 20, the operating condition of the starter 11 may be changed by various factors. For instance, when the starter 11 is not capable of properly operating, as demonstrated in FIG. 2(b), it will result in an insufficient increase in speed of the engine 10. In such an event, the start time when the alternator 20 is actuated in the motor mode may be delayed.

More specifically, the engine starting system of this embodiment uses the alternator 20 which is of a sensor-less type with an ac motor. After the starter 11 starts to be driven, the alternator 20 is also rotated by rotation of the starter 11. Therefore, when it is required to start the alternator 20 in response to the alternator command signal, the controller 22 determines which phase winding of the alternator 20 should be excited and then control energization of the alternator 20 in accordance with the phase winding to be excited to achieve the motor mode of the alternator 20. When the speed of the alternator 20 while being rotated by the rotation of the starter 11 is low, it requires an increased time for starting the alternator 20 in the motor mode, thus resulting in a delay in starting the alternator 20. This may result in insufficient assistance of the alternator 20 in cranking the engine 10, which leads to a concern about a deterioration in startability of the engine 10.

The engine starting system of this embodiment is, therefore, designed to obtain information about start of the motor mode of the alternator 20 (i.e., a starting condition representing the initial operation of the alternator 20) in time sequence as a second parameter which correlates with the operating condition of the alternator 20 after the drive command is received by the controller 22 to start actuation of the alternator 20. The engine starting system then determines the stop time at which the starter 11 should be turned off as a function of the second parameter to control a time interval between the stop of the starter 11 and the start of the alternator 20. In other words, the engine starting system of this embodiment anticipates the degree to which the alternator 20 assists in cranking the engine 10 and then calculates the stop time of the alternator 20 using the second parameter, thereby optimizing the operation of the starter 11 at the initial staring stage of the engine 10.

Specifically, when the alternator 20 is determined as being expected to be insufficient in assisting cranking the engine 10, the engine starting system postpones stopping the starter 11. More specifically, when the alternator 20 is determined as being expected to be insufficient in assisting the start-up of the engine 20, the engine starting system delays turning off of the starter 11 to increase a time interval between the on-durations of the starter 11 and the alternator 20 for ensuring the stability in starting up the engine 10. For instance, when it is determined that an increased time is expected to be required by the alternator 20 to properly complete the start-up of the engine 10 or the aging of the battery 31 is too great to deliver an amount of electric power to the alternator 20 required to properly complete the start-up of the engine 10, the engine starting system concludes that the alternator 20 is expected to be insufficient in assisting the start-up of the engine 10.

The engine starting system of this embodiment is engineered to stop actuating the starter 11 after the alternator 20 starts to be turned on to create an overlap between the on-durations of the starter 11 and the alternator 20.

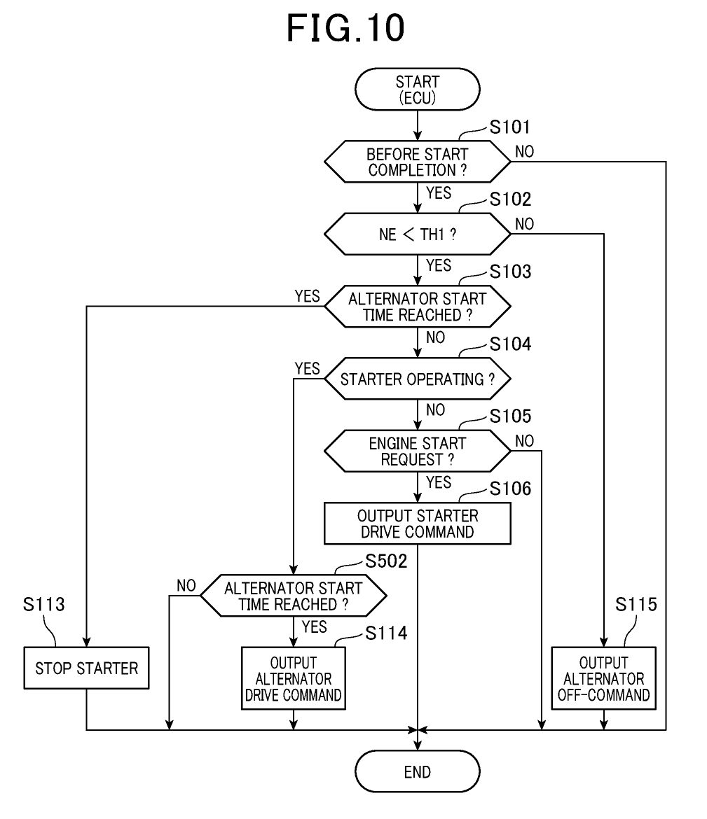

FIG. 10 illustrates a flowchart of a sequence of logical steps or program executed by the ECU 30 of this embodiment in a cycle instead of that in FIG. 3. The engine starting system of this embodiment stops actuating the starter 11 when the ECU 30 receives the starter stop command, as outputted from the controller 22. The same step numbers as employed in FIG. 3 refer to the same operations, and explanation thereof in detail will be omitted here.

In FIG. 10, when the start of the engine 10 has not yet been completed, and the engine speed NE is lower than the threshold value TH1, that is, YES answers are obtained in steps S101 and S102, the routine proceeds to step S501 wherein it is determined whether the starter stop command, as outputted from the controller 22, has been received or not. If a NO answer is obtained meaning that the ECU 30 has not yet received the starter stop command, then the routine proceeds to step S104 wherein it is determined whether the starter 11 is being driven in response to the engine start request or not. If a YES answer is obtained, then the routine proceeds to step S502.

In step S502, it is determined whether the start time of the alternator 20 has been reached or not. The start time of the alternator 20 is determined in advance in this embodiment and set to a time, for example, after a given period of time passes following start of the starter 11, but before the starter 11 should be stopped. If a YES answer is obtained in step S502, then the routine proceeds to step S114 wherein the alternator drive signal is outputted to the controller 22. Alternatively, if a NO answer is obtained, then the routine terminates.

The start time of the alternator 20 may be determined in advance so as to create an overlap between the on-durations of the starter 11 and the alternator 20 regardless of the operating condition of the starter 11.

If a YES answer is obtained in step S501 meaning that the starter stop command, as outputted from the controller 22, is received after the alternator drive command is outputted, then the routine proceeds to step S113 wherein the starter 11 is turned off.

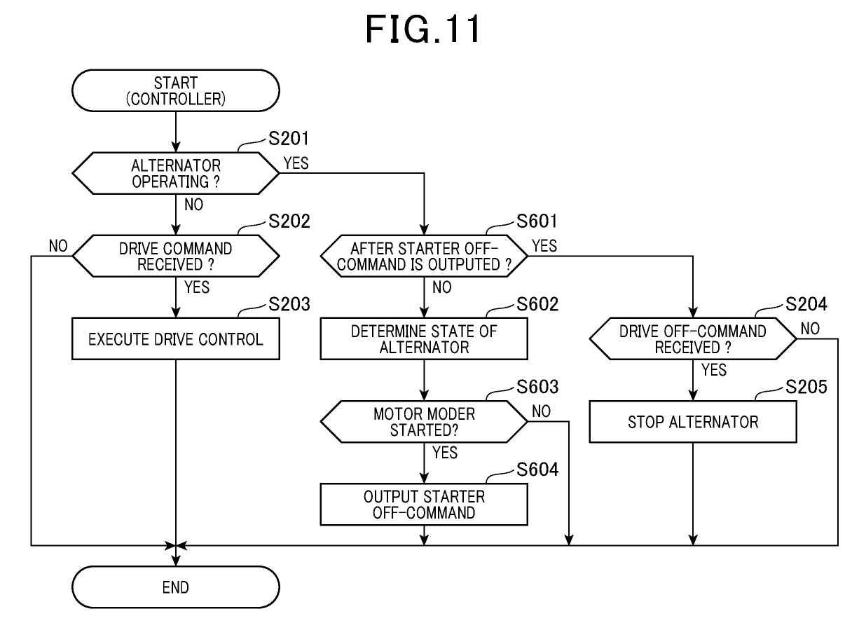

How to determine the stop time of the starter 11 in the controller 22 will be described below in detail with reference to FIG. 11. FIG. 11 is a flowchart of a program executed in a cycle by the controller 22 instead of the program of FIG. 6. The program of FIG. 11 may be executed in a given control cycle which may be identical with or different from that in the ECU 30.

After entering the program, the routine proceeds to step S201 wherein it is determined whether the alternator 20 is now operating or not. If a NO answer is obtained meaning that the alternator 20 is not being driven, then the routine proceeds to step S202 wherein it is determined whether the controller 22 has received the alternator drive command from the ECU 30 or not. If a NO answer is obtained in step S202 meaning that the alternator 20 is inhibited from operating in the motor mode, the routine then terminates without placing the alternator 20 in the motor mode. Alternatively, if a YES answer is obtained in step S202 meaning that the alternator 20 is permitted to be driven in the motor mode, then the routine proceeds to step S203 wherein the drive control is executed to drive the alternator 20. If a YES answer is obtained in step S201 meaning that the alternator 20 is operating, then the routine proceeds to step S601 wherein it is determined whether the starter stop command has been outputted to the ECU 30 or not. If a YES answer is obtained, then the routine proceeds to step S204. Alternatively, if a NO answer is obtained, then the routine proceeds to step S602.

In step S602, information about start of the motor mode of the alternator 20 after the controller 22 receives the drive command to start the alternator 20 is obtained as the second parameter. Specifically, information about the fact that the controller 22 has determined one of the phase windings thereof which is required to be subsequently excited and then started actuating the alternator 20 is obtained.

Subsequently, the routine proceeds to step S603 wherein it is determined whether the alternator 20 has been turned on and placed in the motor mode or not. If a YES answer is obtained, then the routine proceeds to step S604 wherein the starter stop command is outputted to the ECU 30. In this case, the starter 11 continues to be driven until the alternator 20 is started to be driven in the motor mode. When it is determined that the start of the alternator 20 in the motor mode is expected to be delayed by various factors, that is, the alternator 20 is in an insufficient-assist condition where the alternator 20 is expected to be insufficient in assisting the start-up of the engine 10, the stop time of the starter 11 is postponed.

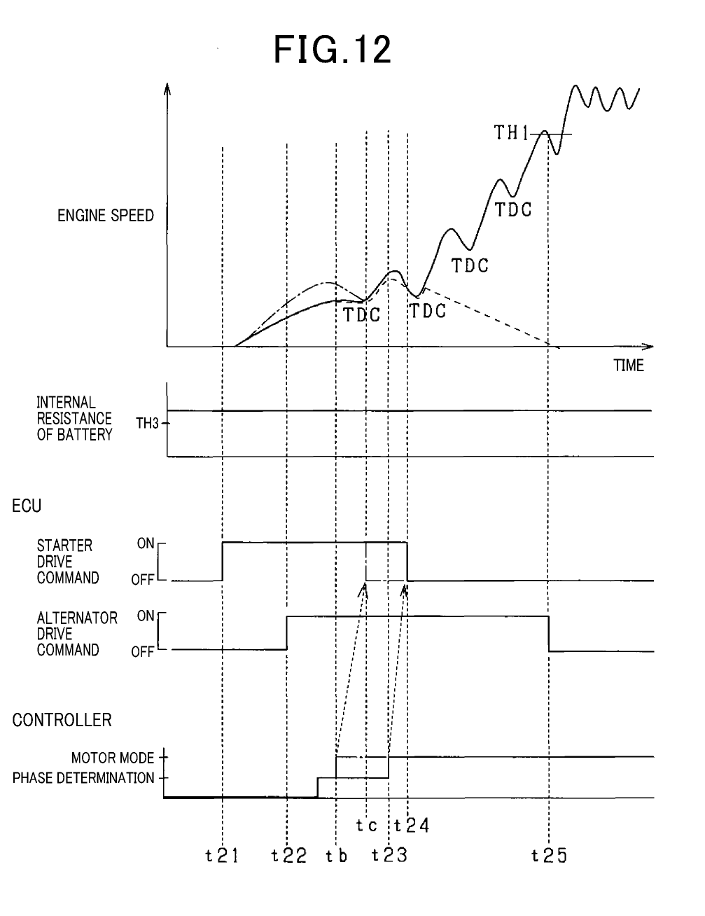

FIG. 12 is a time chart which demonstrates the control tasks in FIGS. 10 and 11. In the example of FIG. 12, after having been automatically stopped, the engine 10 is restarted in the idle stop mode.

Before time t21, the engine 10 is at rest. When the driver of the vehicle has made an engine start request at time t21, the ECU 30 outputs the starter drive command to start actuating the starter 11. At time t22, the ECU 30 produces the alternator drive command and outputs it to the controller 22. When receiving the alternator drive command, the controller 22 starts controlling the energization of the alternator 20. Specifically, the controller 22 determines which phase windings of the alternator 20 should be next excited and then starts energizing the alternator 20 based on the determined phase winding to operate the alternator 20 in the motor mode.

In the example of FIG. 12, the rate of increase in speed of the engine 10 cranked by the starter 11 is lowered due to, for example, the aging of the battery 31 (e.g., the internal resistance of the battery 31 which has become higher than or equal to the threshold value TH3). This will cause the start-up of the motor mode of the alternator 20 to be delayed. When the alternator 20 starts operating in the motor mode at time t23, the controller 22 outputs the starter stop command to the ECU 30. When receiving the starter stop command at time t24, the ECU 30 stops actuating the starter 11. The starter 11, thus, continues to be driven until the alternator 20 starts operating in the motor mode.

When the speed of the engine 10 is increasing at a desired rate, the alternator 20 starts operating in the motor mode at time tb. Subsequently, the ECU 30 receives the starter stop command at time tc. Alternatively, when the speed of the engine 10 is increasing at a lower rate, the start of the alternator 20 in the motor mode will be delayed. The controller 22, thus, delays outputting the starter stop command, thereby compensating for a lack of assistance of the alternator 20 in staring up the engine 10 which arises from the lag in the start of the motor mode of the alternator 20.

When the ECU 30 and the controller 22 alternately communicate with each other, a lag usually occurs in such communications. In the example of FIG. 12, an interval between times t23 and t24 represents such a lag.

The engine starting system of this embodiment, as described above, obtains the second parameter correlating with the operating condition of the alternator 20 and controls an interval or overlap between the stop of the starter 11 and the start of the alternator 20 as a function of the second parameter. When the alternator 20 is expected to be insufficient in assisting the start-up of the engine 10, it is necessary to increase the degree to which the starter 11 cranks the engine 10 at an early stage to start up the engine 10. To this end, the engine starting system of this embodiment works optimize the on-durations of the starter 11 and the alternator 20 to ensure the stability in starting up the engine 10.

Specifically, the engine starting system, as described already, determines the time when the starter 11 should be stopped using the second parameter. The use of the second parameter correlating with the operating condition of the alternator 20 enables an expected degree of assistance of the alternator 20 in starting up the engine 10 to be derived for determining whether the alternator 20 is capable of increasing the speed of the engine 10 at a desired rate or not. The engine starting system determines the stop time of the starter 11 based on the second parameter, thereby ensuring the stability in starting up the engine 10.

When the alternator 20 is expected to be insufficient in the assistance in starting up the engine 10, it is necessary to increase a load on the starter 11 to start the engine 10 as compared with that on the alternator 20. To this end, the engine starting system of the second embodiment delays the stop of the starter 11 to increase an overlap between the on-durations of the starter 11 and the alternator 20, thereby increasing the load on the starter 11 to crank the engine 10 to improve the startability of the engine 10.

The engine starting system obtains information about the state of the motor mode of the alternator 20 in time sequence as the second parameter correlating with the operating condition of the alternator 20 after the controller 22 receives the drive command and uses the information to determine whether the alternator 20 is expected to desirably assist in starting up the engine 10 or not. This enables a combination of the operations of the starter 11 and the alternator 20 to be optimized.

The engine starting system may alternatively be designed to derive the state (e.g., the terminal voltage or degree of aging) of the battery 31 delivering electric power to the alternator 20 or a cold condition of the engine 10 (e.g., an ambient temperature or temperature of engine coolant) as the second parameter. In this case, the ECU 30 obtains the second parameter and determines the stop time of the starter 11 using the second parameter. For instance, the ECU 30 postpones the stop time of the starter 11 as the terminal voltage at the battery 31 or the temperature of the coolant decreases.

### Third Embodiment

The engine starting system of the third embodiment will be described below. The engine starting system of the first embodiment has the battery 31 to which the starter 11 and the alternator 20 are electrically connected and supplies electrical power both to the starter 11 and to the alternator 20 from the battery 31, while the engine starting system of the third embodiment has separate batteries which deliver electrical power to the starter 11 and the alternator 20, respectively.

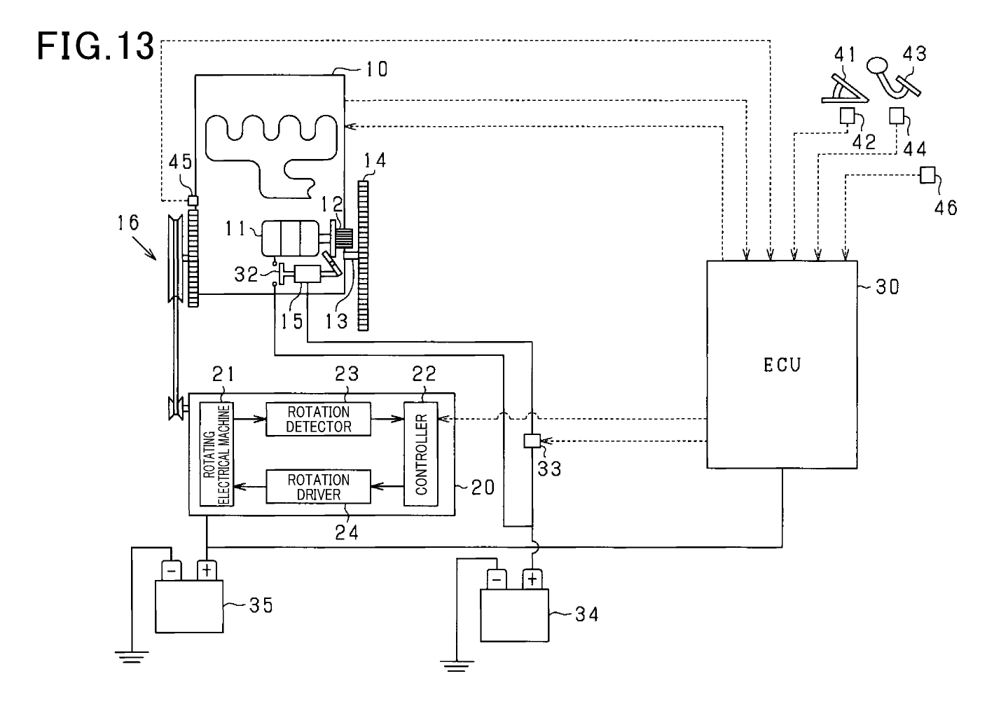

FIG. 13 schematically illustrates the structure of the engine starting system of the third embodiment. The battery 34 is electrically joined to the starter 11 and serves as a first power supply which delivers electrical power to actuate the starter 11. The battery 35 is electrically connected to the alternator 20 and serves as a second power supply which delivers electrical power to actuate the alternator 20. Specifically, when it is required to operate the alternator 20 as an electrical motor, the battery 35 supplies the electrical power to the alternator 20 through an inverter circuit. The ECU 30 connects with the battery 35, so that it operates using the electrical power delivered from the battery 35. The ECU 30 is capable of sequentially obtaining the state of each of the batteries 34 and 35. Other arrangements are identical with those in the first embodiment, and explanation thereof in detail will be omitted here.

The engine starting system of the third embodiment obtains the state of the battery 35 as the second parameter and determines the stop time of the starter 11 as a function of the second parameter to control an interval between the stop of the starter 11 and start of the alternator 20. In other words, the engine starting system derives, as the second parameter, the state of the battery 35 which is electrically separate from the starter 11, thereby improving the accuracy in determining the operating condition of the alternator 20.

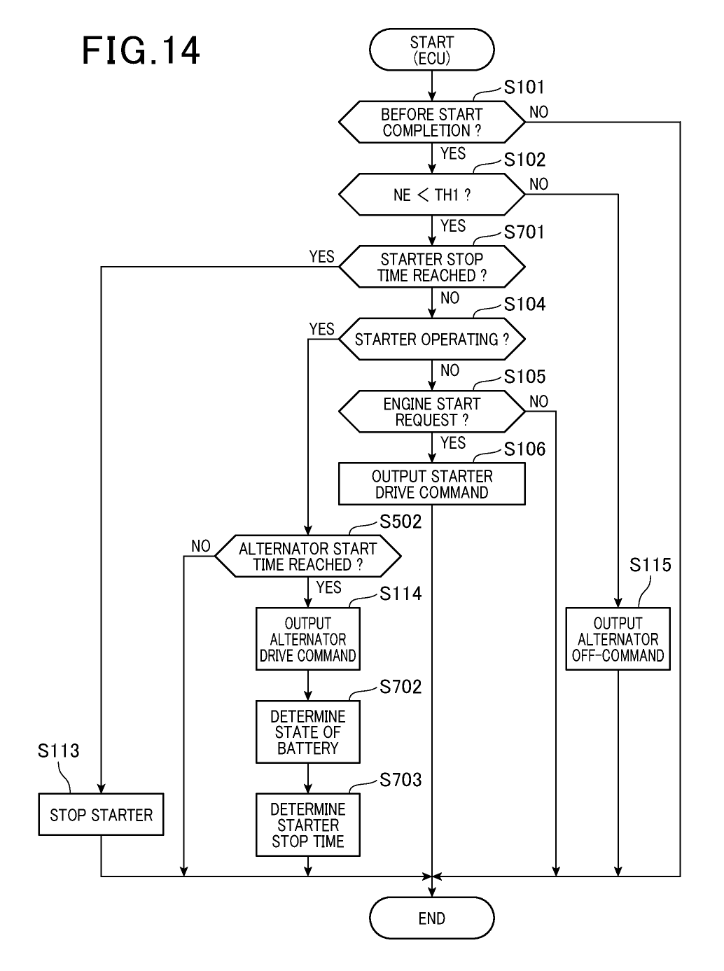

FIG. 14 illustrates a flowchart of a sequence of logical steps or program executed by the ECU 30 of the third embodiment in a cycle to determine the stop time of the starter 11 using the second parameter. The program is performed instead of that in the second embodiment of FIG. 10. The same step numbers as employed in FIG. 10 refer to the same operations, and explanation thereof in detail will be omitted here.

In FIG. 14, when the start of the engine 10 has not yet been completed, and the engine speed NE is lower than the threshold value TH1, that is, YES answers are obtained in steps S101 and S102, the routine proceeds to step S701 wherein the ECU 30 determines whether the stop time of the starter 11 has been reached or not. If a YES answer is obtained, then the routine proceeds to step S113. Alternatively, if a NO answer is obtained, then the routine proceeds to step S104.

In step S104, it is determined whether the starter 11 is being driven or not. If a YES answer is obtained meaning that the starter 11 is operating, then the routine proceeds to step S502 wherein it is determined whether the start time of the alternator 20 is reached or not. If a YES answer is obtained in step S502, then the routine proceeds to step S114 wherein the alternator drive signal is outputted to the controller 22. The routine then proceeds to step S702.

In step S702, a parameter indicating the state of the battery 35 is derived as the second parameter. Specifically, the ECU 30 obtains the internal resistance of the battery 35. The routine then proceeds to step S703 wherein the stop time of the starter 11 is determined as a function of the internal resistance of the battery 35.

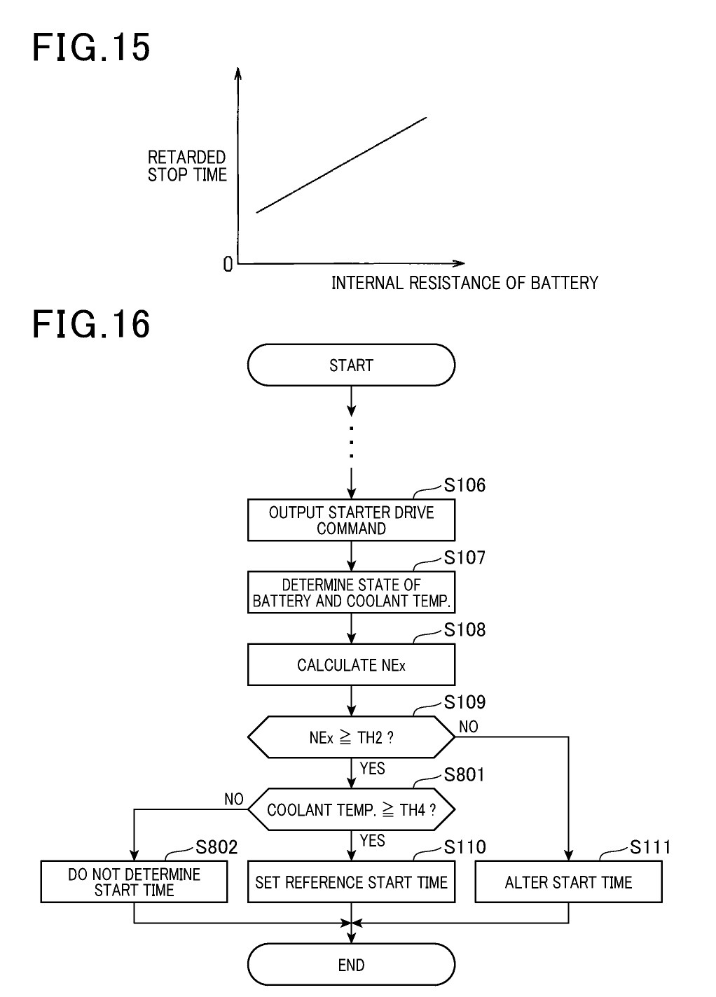

The stop time of the starter 11 may be calculated using a map shown in FIG. 15. The map represents a relation between the internal resistance of the battery 35 and the stop time of the starter 11 which is delayed as a function of a value of the internal resistance. Specifically, the stop time of the starter 11 is retarded with an increase in the internal resistance of the battery 35. This is because if the internal resistance of the battery 35 is increased, it will result in a decrease in electrical power delivered to the alternator 20, which leads to a lack of torque produced by the alternator 20 to crank the engine 10, in other words, a lack of assistance of the alternator 20 in starting up the engine 10. The engine starting system, therefore, delays the stop time of the starter 11 to increase the length of time the starter 11 operates to compensate for the lack of assistance of the alternator 20 in cranking the engine 10.

Afterwards, when the stop time of the starter 11 is reached, a YES answer is obtained in step S701. The routine then proceeds to step S113 wherein the starter 11 is turned off.

The operation of the controller 22 in the third embodiment is identical with that in FIG. 6. The ECU 30 is, unlike the second embodiment, designed to determine the stop time of the starter 11.

The starter 11 and the alternator 20 are electrically connected to the batteries 34 and 35, respectively. Accordingly, when one of the batteries 34 and 35 is in an undesirable state, while the other of the batteries 34 and 35 is in a required state, the engine starting system may control the operations of the starter 11 and the alternator 20 using at least one of the first parameter and the second parameter, thereby optimizing the start-up of the engine 10.

Either of the first parameter or the second parameter may be used as indicating the state of the battery 34 or 35. This enables the engine starting system to have an increased accuracy in determining the amount of electric power delivered to the starter 11 or the alternator 20 to obtain the operating condition thereof.

The ECU 30 is, as described above, designed to obtain the second parameter and determine the stop time of the starter 11. This eliminates the need for establishing communication between the ECU 30 and the controller 22 which is required for controlling on- and off-operations of the starter 11, thus facilitating the control of the operation of the starter 11.

The engine starting system may alternatively be designed to obtain a parameter indicating the state of the battery 34 as the first parameter and determine the start time of the alternator 20 as a function of the first parameter.

### Modifications

The engine starting system in each of the above embodiments may be modified as described below.

The engine starting system may be designed to execute a combination of two tasks: one being to determine the start time of the alternator 20 using the first parameter, and the other being to determine the stop time of the starter 11 using the second parameter. Specifically, the engine starting system obtains both the first and second parameters, calculates the start time of the alternator 20 as a function of the first parameter, and also calculates the stop time of the starter 11 as a function of the second parameter. This optimizes the on-durations of the starter 11 and the alternator 20 to enhance the startability of the engine 10.

The engine starting system may alternatively be engineered not to operate the alternator 20 for starting up the engine 10. For example, when the starter 11 is in a condition capable of completing the start-up of the engine 10, the engine starting system may use only the starter 11 to crank the engine 10.

The above structure of the engine starting system will be described below in detail with reference to FIG. 16. FIG. 16 illustrates only a portion of a sequence of steps (i.e., steps S106 to S111) identical with that in FIG. 3 for the sake of simplicity of disclosure.

In the program of FIG. 16, when an engine start request to start the engine 10 is made, the routine proceeds to step S106 wherein the starter drive command is outputted to the relay 33 to actuate the starter 11. The routine then proceeds to step S107 wherein a parameter indicating the state of the battery 31 and a parameter indicating the temperature of coolant (e.g., cooling water) for the engine 10 are derived as the first parameter. The internal resistance of the battery 31 is used as the parameter indicating the state of the battery 31. The routine proceeds to step S108 wherein the engine speed NEx is calculated as a function of the internal resistance of the battery 31.

Subsequently, the routine proceeds to step S109 wherein it is determined whether the engine speed NEx, as estimated in step S108, is greater than or equal to the threshold value TH2 or not. If a NO answer is obtained meaning that the speed of the engine 10 is expected to fall in an undesirable low range smaller than the threshold value TH2, then the routine proceeds to step S111 wherein the start time of the alternator 20 is altered.

Alternatively, if a YES answer is obtained in step S109 meaning that the speed of the engine 10 is expected not to fall in the undesirable low range, then the routine proceeds to step S801 wherein it is determined whether the temperature of the coolant is higher than or equal to the threshold value TH4 or not. The threshold value TH4 is a reference value used in determining whether the engine 10 is in a cold condition or not. If a YES answer is obtained in step S801 meaning that the engine 10 is not in the cold condition, that is, that the engine 10 has been warmed up, then the routine proceeds to step S802 wherein the start time of the alternator 20 is not determined. In other words, the engine starting system does not use the alternator 20 in this engine starting cycle to crank the engine 10. Alternatively, if a NO answer is obtained in step S801 meaning that the engine 10 is in the cold condition, then the routine proceeds to step 11o wherein the start time of the alternator 20 is set to the reference start time.

As apparent from the above discussion, the engine starting system works to start up the engine 10 without use of the alternator 20 when the engine 10 is not in the cold temperature condition, so that the speed of the engine 10 is expected to be desirably increased by the starter 11.

The engine starting system may be designed to determine whether the starter 11 is in a condition capable of being desirably driven, but the alternator 20 is in a condition not capable of being desirably driven or not. When the alternator 20 is determined to be in the condition not capable of being desirably driven, the engine starting system may use only the starter 11 to start up the engine 10.

The first parameter or the second parameter may be a parameter indicating the fact that the engine 10 is in the cold condition. For instance, such a parameter is the temperature of outside air or the temperature of the coolant of the engine 10 which may be measured by an ambient temperature sensor or a coolant temperature sensor installed in the vehicle. For example, when the first parameter indicating the temperature of the coolant is lower than a given threshold value, meaning that the engine 10 is in the cold condition, the engine starting system may advance the start time of the alternator 20.

The ECU 30 may be designed to control the on- and off-operations of the starter 11 and also to control the operation (e.g., the rotation) of the alternator 20.

The engine starting systems in the above embodiments have installed therein the alternator 20 as a second starter which is not equipped with a rotation sensor, but may alternatively be designed to use the alternator 20 equipped with the rotation sensor.

The starter 11 may be implemented by a so-called tandem starter equipped with a pinion-shifting solenoid and a motor-actuating solenoid.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modifications to the shown embodiment which can be embodied without departing from the principle of the invention as set forth in the appended claims.

1. An engine starting system for starting an engine mounted in a vehicle, comprising:
a first starter;
a second starter; and
an engine start controller which is responsive to an engine start request to first activate the first starter and then actuate the second starter for starting up the engine, the engine start controller working to obtain at least one of a first parameter and a second parameter, the first parameter correlating with an operating condition of the first starter, the second parameter correlating with an operating condition of the second starter, the engine start controller controlling an interval between a stop time at which the first starter is stopped and a start time at which the second starter is started as a function of the at least one of the first and second parameters.

2. An engine starting system as set forth in claim 1, wherein the engine start controller determines the start time of the second starter as a function of the first parameter to control the interval between the stop time of the first starter and the start time of the second starter.

3. An engine starting system as set forth in claim 2, wherein the engine start controller determines whether a speed of the engine cranked by the first starter is expected to fall in a low range smaller than a given threshold value or not using the first parameter, and wherein when it is determined that the speed of the engine is expected to fall in the low range, the engine start controller advances the start time of the second alternator.

4. An engine starting system as set forth in claim 1, wherein the engine start controller obtains, as the first parameter, at least one of a peak value of a speed of the engine driven by the first starter, a rate of increase in speed of the engine driven by the first starter, a state of a power supply which works to delivers electric power to the first starter, and a cold temperature condition of the engine.

5. An engine starting system as set forth in claim 1, wherein the engine start controller determines the stop time of the first starter as a function of the second parameter to control the interval between the stop time of the first starter and the start time of the second starter.

6. An engine starting system as set forth in claim 5, wherein the engine start controller determines whether the second starter is in an insufficient-assist condition where the second starter is expected to be insufficient in assisting starting up the engine or not, and wherein when the second starter is determined to be in the insufficient-assist condition, the engine start controller delays the stop time of the first starter.

7. An engine starting system as set forth in claim 1, wherein the engine start controller obtains, as the second parameter, at least one of information about a starting condition of the second starter, a state of a power supply delivering electric power to the second starter, and a cold condition of the engine.

8. An engine starting system as set forth in claim 1, wherein the engine start controller operates in a control mode to control an operation of each of the first starter and the second starter based on at least one of the first and second parameters, the control mode including a mode in which the second starter is inhibited from operating.

9. An engine starting system as set forth in claim 1, further comprising a first power supply for the first starter and a second power supply for the second starter, and wherein the engine start controller obtains the first parameter when it is required to actuate the first starter using electric power delivered from the first power supply and also obtains the second parameter when it is required to actuate the second starter using electric power delivered from the second power supply.
